(19) United States
(12) Patent Application Publication
(10) Pub. No.: US 2021/0144939 A1
(43) Pub. Date: May 20, 2021

(54) GROW PLUG PROVIDED WITH A SEED GRAIN, AS WELL AS METHOD OF MANUFACTURING THE GROW PLUG

(71) Applicant: Gerbrandus Janus APPELS, Goirle (NL)

(72) Inventor: Gerbrandus Janus APPELS, Goirle (NL)

(21) Appl. No.: 17/159,504

(22) Filed: Jan. 27, 2021

Related U.S. Application Data
(63) Continuation-in-part of application No. 15/549,904, filed on Aug. 9, 2017.

(30) Foreign Application Priority Data
Feb. 13, 2015 (NL) 2014290
May 21, 2015 (NL) 2014834

(51) Int. Cl. A01G 24/44; A01C 1/04; A01G 24/23; A01G 9/029

(52) U.S. Cl. CPC A01G 24/44; A01G 9/0291; A01G 24/23; A01C 1/046

(57) ABSTRACT

A grow plug 1 has a dimensionally stabilized dried body 3 of glued organic material as well as at least a single seed grain 5. The seed grain is present on the body and the body has a density that is such that it absorbs liquid from below up to the top side and retains an amount of water that is sufficient for having the seed grain germinate and grow into a plant.

When a plant is cultivated by means of this grow plug 1 the grow plug is put in the soil 25 or in a cultivation system and subsequently moistened by pouring water from above onto the grow plug, where the redundant water is drained by the grow plug or the grow plug is inserted into water 21 with its bottom side, and the grow plug sucks up water and some time after the germination of the seed grain the grow plug is put in the soil 25 or in the cultivation system.

### FIELD OF THE INVENTION

The invention relates to a grow plug, comprising a dimensionally stabilized optionally dry body of organic material, provided with a means for holding together the organic material, as well as at least a single seed grain which is present on the body and is connected to the body.

A dimensionally stabilized body in this context is understood to be a body that retains its shape under its own weight and when held, this contrary to a non-dimensionally stabilized body of, for example, material that sags in under its own weight or disintegrates when held.

### STATE OF THE ART

A grow plug of similar kind is known from DE2544699A. In this known grow plug the means that provides that the organic material is held together is formed by a dense water-soluble or water-softening layer which is attached to or around the body surface.

### SUMMARY OF THE INVENTION

It is an object of the invention to provide a grow plug of the type defined in the opening paragraph in which the nutritional value, acidity value and during use the air-to-water ratio can be precisely determined beforehand. For this purpose the grow plug according to the invention is characterized in that the means for holding together the organic material is formed by glue present among components of the organic material, by which glue the components are bonded so that the body per se is dimensionally stabilized. Organic material comprising components glued together is capable of retaining means such as nutrients and acidity increasing or acidity reducing means better than non-glued organic material. In addition to this the organic material either provided or not with the means mentioned above can be stored better in a dry condition than in a wet or moist condition. In consequence, the seed grain can germinate faster during use and a resulting seedling can grow faster.

It should be observed that from JP2013039124A is known a grow plug in which a seed grain is deposited in the middle of the body. This known grow plug is to be inserted into the soil. After being watered regularly the seed will germinate and the seedling will grow while the seedling can extract nutrients from the body.

The means preferably exclusively comprises said glue so that a cost-effective grow plug can be obtained. Furthermore, the glue is preferably a glue being not soluble in water, so that also during use a dimensionally stabilized body is retained even after moistening. The grow plug according to the invention can be designed such that after moistening it extracts exactly the right amount of water for the seedling to grow to an optimum degree.

The body preferably has a density that is such that this body absorbs liquid from below up to the top side and moistens the seed grain there and allows it to germinate. The body preferably retains an amount of water that is sufficient for causing the seed grain to germinate and grow into a plant.

An embodiment of the grow plug according to the invention is characterized in that the seed grain is glued to the body, utilizing, in some embodiments, a water-soluble glue. During the moistening of the grow plug the glue preferably dissolves, so that the seed grain softens after the dissolution of the glue and germinates and during the germination process can orient itself to the optimum direction.

A further embodiment of the grow plug according to the invention is characterized in that the seed grain is present on the body and a film covers the seed grain and is connected to the body around the seed grain. The film is to be removed before use. The advantage of this embodiment over the embodiment described above is that the seed grain during the germination process can orient itself to the optimum direction from the start and is not forcibly retained. Neither is there any hazard of the seed grain being affected by the glue. In some embodiments, glue is not used to attach the seed grain to the body.

Preferably the top side of the body has a recess in which the seed grain is accommodated. This recess may exceed the size of the seed grain so that the seed grain can freely orient itself during the germination process. The recess may also fall short of the size of the seed grain where the seed grain is then pushed into the recess and is fixedly clamped in the body, so that no film or glue is needed to retain the seed grain and the seed grain can breathe all around.

For enclosing the seed grain in the recess and/or underneath the film, preferably container mulch is present on top of or around the seed grain. The container mulch is for example granular coconut, cork or perlite.

Furthermore, the grow plug preferably contains nutrients which are present in the body among the organic material.

In order to avoid that no germination takes place as a consequence of a bad seed grain, the grow plug comprises at least a single further seed grain.

In some embodiments, the organic material is in the form of dry chips, or in other embodiments, has been dried into chips. In further embodiments, the dry or dried chips are then shaped into a body and directly glued together by a non-water-soluble glue. In certain embodiments, the non-water-soluble glue is the only adhesive present in the body. However, in still further embodiments, a small amount of water-soluble glue is additionally used, to attach the seed to the grow plug.

In yet other embodiments, the body of organic material is dry. In certain embodiments, the body has been dried after being glued together.

In certain embodiments, the invention does not encompass grow plugs wherein the organic material was formed into intermediate structures, e.g., sheets or layers, prior to gluing the material to generate the grow plug. The herein-described grow plugs exhibit significant reduced production cost and enhanced production speed, relative to prior grow plugs. The invention likewise relates to a method of manufacturing a grow plug in which components of organic material are formed into a body and are dried and, subsequently, at least a single seed grain is deposited on the top side of the body and is connected to the body.

With the known grow plug the dimensional stability is rendered to the organic material formed into a body in that a layer is applied to the body surface or around the body. With respect to the method the invention is characterized in that forming the organic material components into a dried body is realized by bonding together the components of the organic material by means of a glue and drying them. In some embodiments, the organic material is dried into chips, which are then shaped into a body and directly glued together by a non-water-soluble glue. In certain embodiments, the non-water-soluble glue is the only adhesive present in the body. However, in still further embodiments, a small amount of water-soluble glue is additionally used, to attach the seed to the grow plug.

In yet other embodiments, organic material that has not been dried or otherwise processed is formed into chips, which are then glued together into a body, as described hereinabove. Optionally, the body is subsequently dried.

In yet other embodiments, the body of organic material is dried after being glued together.

In certain embodiments, the invention does not encompass methods wherein the organic material is formed into intermediate structures, e.g., sheets or layers, prior to gluing the material to generate the grow plug.

The seed grain may be glued to the body or a film may be deposited over the seed grain and glued to the top side of the body.

Prior to the gluing operation preferably nutrients are added to the organic material.

Preferably, two seed grains are deposited on the top side of the body and connected to the body.

### BRIEF DESCRIPTION OF THE DRAWINGS

The invention will be described in more detail based on examples of embodiment of the grow plug according to the invention while reference is made to the appended drawing figures, in which:

FIG. 1 shows a first embodiment of the grow plug according to the invention;

FIG. 2 shows a second embodiment of the grow plug according to the invention;

FIG. 3 shows steps in the cultivation process utilizing the grow plug according to the invention; and

FIG. 4 shows a third embodiment of the grow plug according to the invention.

### DETAILED DESCRIPTION OF THE DRAWINGS

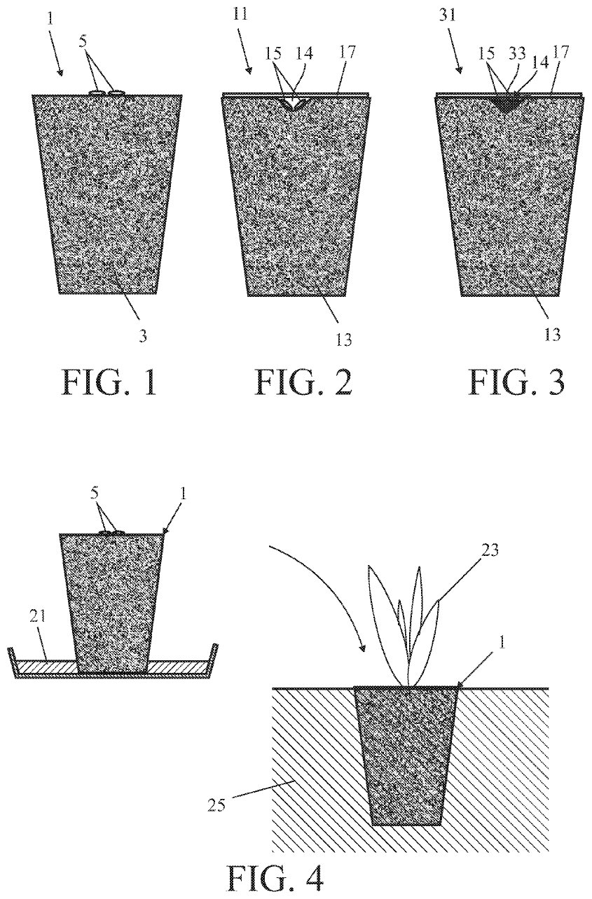

FIG. 1 shows a first embodiment of the grow plug according to the invention. The grow plug 1 comprises a dimensionally stabilized dried body 3 formed by organic material components glued together by means of a glue. A seed grain 5 is glued to the top side of the body. Further the body contains nutrients and acidity increasing or acidity reducing means among the organic material.

FIG. 2 shows a second embodiment of the grow plug according to the invention. This grow plug 11 too has a dimensionally stable, dried body 13 of organic material components glued together. In the top side of the body is provided a recess 14 in which two seed grains 15 are accommodated. The recess containing the seed grains is covered with a film 17 which is detachably glued to the body around the recess.

The body 3 or 13 respectively of the grow plugs 1 and 11 described above has a density that is such that the body absorbs liquid from below up to the top side and retains an amount of water that is sufficient for having the seed grain(s) 5 or 15 respectively germinate and grow into a plant.

FIG. 3 shows a first embodiment of the grow plug according to the invention. The same reference numerals have been used to indicate corresponding features of the second embodiment described above. This embodiment of the grow plug 31 differs from the second embodiment in that in the recess 14 is present container mulch, for example coconut grit 33 on the seed grains 15. During use the coconut becomes moist so that the seed grains are covered with a moist layer which promotes the germination process and growing process. In addition, the seed grains are enclosed in the recess 14 for use and during transport, so that they suffer less from the disturbing effects of being shaken to and fro.

The cultivation process of the grow plug according to the invention is the following. First of all the grow plug 1 is moistened by pouring water from above onto the grow plug, while the surplus of water is drained by the grow plug, or by placing the bottom side of the grow plug in water 21, see FIG. 4, left image, so that the grow plug sucks in water. During the germination of the seed grain and the growing of the plant, the whole should be watered at regular intervals in the way described above. Once a seedling 23 has grown (FIG. 4, right image), the grow plug 1 can be put into the soil 25 or into a cultivation system, after which the seedling can be cultivated further in customary fashion.

Albeit the invention has been described in the foregoing with reference to the drawings, it should be observed that the invention is not by any manner or means restricted to the embodiments shown in the drawings. The invention also extends to all embodiments deviating from the embodiment shown in the drawings within the scope defined by the claims.

1. A grow plug comprising a dimensionally stabilized dry body of organic material and at least a single seed grain present on a top side of the body and connected to the body, said body consisting of chips of organic material shaped into a body and directly glued together by a non-water-soluble glue.

2. A grow plug as claimed in claim 1, characterized in that said organic material is subject to drying, prior to or during formation of said chips.

3. A grow plug as claimed in claim 1, characterized in that said organic material is not subject to drying, prior to or during formation of said chips.

4. A grow plug as claimed in claim 3, characterized in that said body is subject to drying.

5. A grow plug as claimed in claim 1, characterized in that said grow plug is dimensionally stabilized exclusively via said non-water-soluble glue.

6. A grow plug as claimed in claim 1, characterized in that the body has a density that is such that this body absorbs liquid from below up to the top side and moistens the seed grain there and allows it to germinate.

7. A grow plug as claimed in claim 1, characterized in that the seed grain is glued to the top side.

8. A grow plug as claimed in claim 1, characterized in that the seed grain is present on the top side, and a film covers the seed grain and is connected to the top side around the seed grain.

9. A grow plug as claimed in claim 1, characterized in that a recess is provided in the top side, which recess accommodates the seed grain.

10. A grow plug as claimed in claim 9, characterized in that the recess is smaller than or equal to the seed grain, where the seed grain is pushed into the recess and is fixedly clamped in the body.

11. A grow plug as claimed in claim 9, characterized in that container mulch is present around the seed grain.

12. A grow plug as claimed in claim 1, characterized in that the grow plug further includes nutrients which are present in the body among the organic material.

13. A grow plug as claimed in claim 1, characterized in that the grow plug comprises at least a single further seed grain.

14. A method of manufacturing a grow plug comprising making a body of organic material consisting of the following steps: (a) cutting organic material into chips; (b) shaping these organic chips into a body; (c) directly gluing together the organic chips with a non-water-soluble glue; and (d) drying the body.

15. A method as claimed in claim 14, characterized in that at least a single seed grain is glued to a top side of the body.

16. A method as claimed in claim 15, characterized in that at least a single further seed grain is glued to the top side.

17. A method as claimed in claim 14, characterized in that at least a single seed grain present on a top side of the body, and a film is deposited over the seed grain and glued to the top side.

18. A method as claimed in claim 17, characterized in that at least a single further seed grain is present on the top side.

19. A method as claimed in claim 14, characterized in that prior to the gluing operation, nutrients are added to the organic material.

20. A grow plug as claimed in claim 1, characterized in that a recess is provided in the top side, which recess accommodates at least a single seed grain.
